(19) United States
(12) Patent Application Publication
(10) Pub. No.: US 2008/0273427 A1
(43) Pub. Date: Nov. 6, 2008

(54) Case for Screening Magnetic Fields

(75) Inventors: Denis Zimmermann, Zurich (CH); Pascal Schweizer, Schaffhausen (CH)

Correspondence Address: YOUNG & THOMPSON, 209 Madison Street, Suite 500, ALEXANDRIA, VA, 22314, US

(73) Assignee: RICHEMONT INTERNATIONAL SA, VILLARS-SUR-GLANE (CH)

(21) Appl. No.: 11/997,156

(22) PCT Filed: Jul. 21, 2006
(86) PCT No.: PCT/IB2006/002003

§ 371 Date: Apr. 2, 2008

(30) Foreign Application Priority Data
Jul. 29, 2005 (CH) 01270/05

(51) Int. Cl. G04B 43/00

(52) U.S. Cl. 368/293

(57) ABSTRACT

The present invention concerns a case for screening magnetic fields, comprising at least two parts, and more particularly a lower part (4, 5) and a bell-shaped upper part (3). These parts are of a shape such that they are able to envelop a movement (1) of a timepiece. The upper part (3), moreover, is attached in such a way that while attached to the movement, it is able to move in a plane parallel to the movement (1) while it is essentially immobile in a direction normal to this plane.

The present invention concerns a case for screening magnetic fields, according to the preamble of claim 1, this case comprising at least two parts, an upper part and a lower part, adapted to envelop the movement of a timepiece and screen this movement against external magnetic fields; as well as a timepiece having such a case.

It is common more particularly in pilot's watches and other, so-called antimagnetic watches having a desired precision or field of application that make it mandatory to screen or neutralize magnetic fields acting from outside, to adequately protect the movement against the influence of such fields.

This is possible on principle, by designing a movement the function of which will not be influenced by magnetic fields that might be present, for instance by replacing the parts made of steel by parts made of a magnetically nonconductive material.

As a rule, however, it will already suffice to limit a magnetic field that might be acting from outside, to less than 4800 A/m inside the movement, in harmony with standards NIHS 90-10 and SN ISO 764, respectively. For economy, therefore, a screening device made of soft iron normally is preferred so as to achieve an environment at the movement that is almost free of interfering magnetic fields. Even if this solution makes a timepiece larger, a screening case remains a simple and effective means for protecting movements, and primarily movements of mechanical timepieces having the classical regulating organ consisting of balance and spring.

For quite some time, numerous variants of such cases have existed, as can be seen, for instance, from the documents CH 25 165 (1902), CH 122 391 (1926), FR 1 029 181 (1950), CH 317 198 (1954), CH 516 835 (1967), U.S. Pat. No. 3,919,836 (1973), and DE 2 918 373 (1979), where the devices described for the most part consist of at least two parts which, after being joined, largely envelop the movement and protect it against external magnetic fields.

Various difficulties arise in so doing, however, which by no means are all remedied by devices known thus far.

Thus, the magnetic screening action of the case on the one hand will depend on the shape of gaps in the case which, in practice, always are required for allowing the operating elements, the arbors of hands, display discs, and other display trains to pass through, or which are present inasmuch as the case is built up from several parts, so that the movement cannot be enclosed hermetically. Here, several smaller gaps existing next to each other in the case may sometimes behave as if they were a single large gap giving rise to a large interfering magnetic field. This is true in particular, even for narrower annular gaps extending over 360°, such as those normally present at least at the joint between upper and lower part of the case.

On the other hand, known screening cases often are composed of two or three parts, that is, a ring attached directly to the periphery of the movement, a case bottom often held by a spring between the bottom of the movement and the bottom of the case of the timepiece, and which together with the ring may be made as a single part, and a case lid to be attached at the display side of the movement, and often doubling as the dial. It is true, though, that a dial made of soft iron for a variety of reasons is disadvantageous, so for instance since this dial, as a flat component without any landing, will even give rise to a larger annular gap at the ring, and thus to a relatively large interfering magnetic field inside of the screening case, as mentioned above. The size and shape of the annular gap between dial and ring are hard to control in this case, inasmuch as the dial may be uneven on account of manufacturing tolerances and the parts during assembly may have been positioned inaccurately. Even making a dial from soft iron is more difficult than making conventional dials from appropriate alloys, particularly so in complex timepieces having several displays and numerous functions. In addition, a dial made of soft iron, on account of materials properties, deforms rather more readily, so that the positioning of the dial required during assembly of the watch is problematic and leads to more demand for after-sales service.

It is the aim of the present invention to overcome said difficulties, and realize a case for the screening of magnetic fields that represents an economic, simple and efficient protection device, at the same time simplifying manufacture and assembly of the case as well as of the entire timepiece, and improving the magnetic screening action.

This aim is attained by the teaching of claim 1, the invention exhibiting the characteristics recited in claim 1 and/or in the dependent claims.

The object of the invention, to this end, is characterized more particularly in that the upper part of the case is mounted in such a way that, when attached to the movement, it may move in a plane parallel to the movement while being practically unable to move in a direction normal to this plane, that is, having a play in this direction of about 1/100 mm that is needed for the mobility of the upper part parallel to the plane of the movement. When assembled, the upper part owing to its bell shape is form-locking with the lower part of the case, the advantage being that—in view of the mobility of the upper part—the manufacturing tolerances to be maintained for centering of the bell-shaped segment of the upper part and the ring-shaped segment of the lower part may be less severe while at the same time the tolerances in the diameters of these two parts can be made more severe. This has the effect, on the one hand, of simplifying manufacture of these parts and assembly of the case, inasmuch as the upper part is mobile, and on the other hand of improving the screening effect, inasmuch as the mutual fit of the two parts is improved, and thus the annular gap between them and with it the interfering magnetic field inside the case is reduced.

Screws and washers of special shape are advantageous in fastening the bell-shaped upper part in such a way that it is mobile in the plane parallel to the movement, as will be apparent from the dependent claims.

It is advantageous, moreover, that in a timepiece having the screening case according to the invention, the dial may be selected conventionally, inasmuch as the bell-shaped upper part of the case has through holes admitting the feet of a dial that are used to fasten the dial at the movement. Thus, the problems of soft iron when used as a dial are eliminated without exception by the separation of dial and upper part of the case. This is guaranteed more particularly on account of the fact that the top surfaces of said washers enable the dial to be spaced apart from the surface of the bell-shaped upper part above which it is fastened.

Further advantages emerge from the characteristics recited in the dependent claims, and from the description setting forth the invention in detail in the following with the aid of drawings.

The attached drawings represent by way of example several embodiments of a screening case according to the present invention.

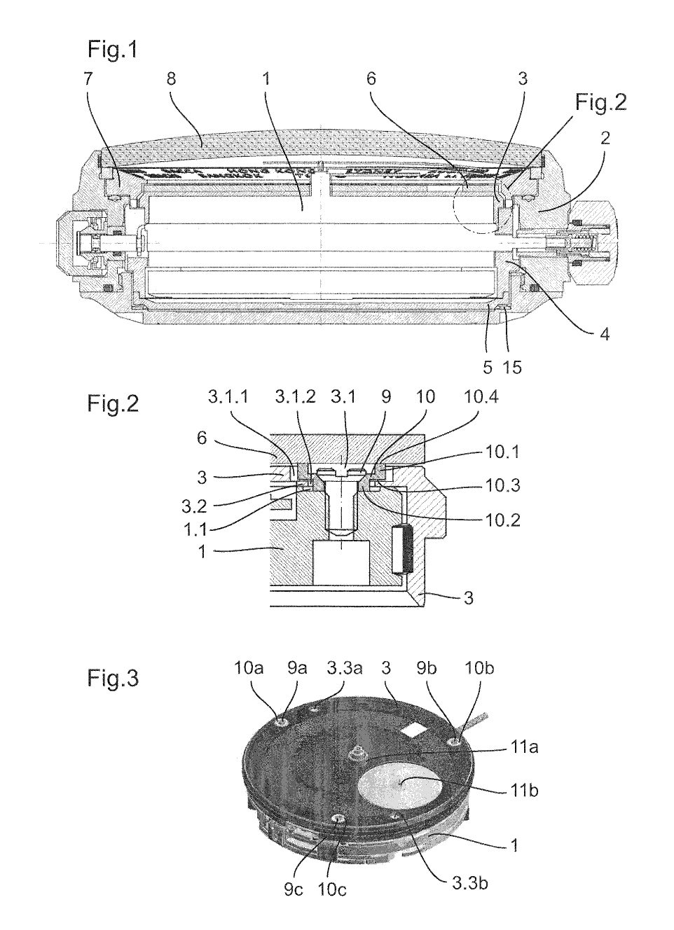

FIG. 1 schematically illustrates in cross section the principles of a timepiece the movement of which is protected by means of a screening case according to the invention.

FIG. 2 is a schematic view of the mobile attachment of the upper part at the movement using screws and washers.

FIG. 3 is a perspective representation of the upper part attached to the movement.

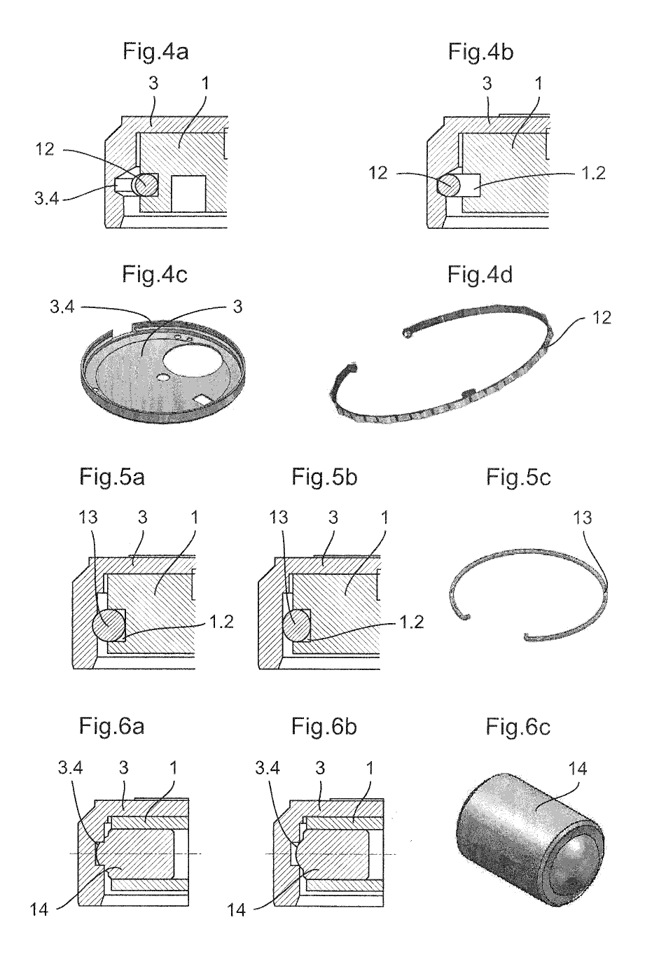

FIGS. 4a and 4b show a first possibility for positioning the bell-shaped upper part at the movement; FIG. 4c represents a perspective view of the upper part with the groove made in its inner wall, while FIG. 4d shows an open annular spring positioned in the groove.

FIGS. 5a and 5b show a second possibility for positioning the bell-shaped upper part at the movement, FIG. 5c represents a matching gasket.

FIGS. 6a and 6b show a third possibility for positioning the bell-shaped upper part at the movement, FIG. 6c represents a matching elastic button.

In the following, the invention will be described in detail with the aid of the drawings mentioned.

Referring to FIG. 1, the principles of a timepiece having a movement protected by a screening case according to the invention will at first be explained. A case according to the present invention serving to screen magnetic fields comprises at least two parts, a lower part 4, 5 and a bell-shaped upper part 3. The lower part 4, 5 and the bell-shaped upper part 3 as a rule consist of soft iron or of another material having similar magnetic properties, and have a shape adapted to have these parts envelop the movement 1 of a timepiece. The lower part preferably consists of two separate parts, a bottom 5 and an annular middle part 4, that can be joined together, but it can also be made as a single part. The annular middle part 4 is fastened directly to the periphery of movement 1 when assembled, the bottom of the screening case normally is held by a spring 15 between the bottom of the movement and the bottom of case 2 of the timepiece, these attachments adapted to be produced in a conventional way. The upper part 3 corresponds to a case lid, the bell shape of this part allowing a form-locking fit to be produced between upper part 3 and lower part 4, 5. The bell-shaped segment of upper part 3 may either envelop the annular middle part 4 or be inserted into it. The bell shape of the upper part 3 here serves, amongst other things, to reduce the radial gap between upper part 3 and annular middle part 4, so as to keep the interfering magnetic field inside the case as low as possible.

Moreover, when assembled the bell-shaped upper part 3 is attached to the movement 1 in such a way that it may move in a plane parallel to movement 1 but is essentially unable to move in a direction normal to this plane. In this direction the upper part 3 has a vertical play of at most about 1/100 mm that is needed for its mobility along the plane of the movement. It can be seen from FIG. 2 that an attachment of the bell-shaped upper part 3 to movement 1 such that mobility exists in a plane parallel to the movement, can be achieved for instance with screws 9 and washers 10 leaving a play of about 0.1 mm to the upper part 3 in all directions within said plane while normal to this plane it is loaded, and for this reason has almost no play in this direction. Moreover, the bell-shaped upper part 3 has cylindrical passages 3.1 enabling screws 9 and washers 10 to be fastened to movement 1.

To this end, more particularly, both the washers 10 and the passages 3.1 in the upper part 3 have a special shape such that they will not interfere with the mobile attachment of upper part 3 at movement 1. On the one hand, this shape is such that each washer 10 in its longitudinal direction has two segments 10.1, 10.2 of different diameters that may be regarded as two superimposed rims of different size, insofar as washer 10 in its center has a hole receiving the screw 9. The bottom side 10.3 of the upper, larger segment 10.1 of washer 10 is adapted—see FIG. 2—to hold the bell-shaped upper part 3 against movement 1 on which it reposes.

On the other hand, each passage 3.1 in the bell-shaped upper part 3 also includes two segments 3.1.1, 3.1.2 of different diameters, each of a slightly larger size than the corresponding segments 10.1, 10.2 of washer 10 that are to be positioned in them. On the one hand, this produces an annular projection 3.2 in the lower part of passage 3.1 on which said bottom side 10.3 of the upper, larger segment 10.1 of washer 10 reposes. This has the effect that upper part 3 will essentially not be able to move in a direction normal to the plane of the movement. On the other hand, play is created by the inner diameter of passage 3.1 being slightly larger than the outer diameters of washer 10, this play making it possible for upper part 3 to remain mobile in a horizontal direction when attached to movement 1, that is, in a plane parallel to movement 1.

That the upper part 3 will be essentially immobile in a vertical direction, that is, in a direction normal to said plane, can preferably be attained by recesses 1.1 made in movement 1 opposite to the cylindrical passages 3.1 of the bell-shaped upper part 3, these recesses having a diameter slightly larger than that of the lower segment 10.2 of washer 10. The depth of the recesses 1.1 is selected so that together with the thickness of projection 3.2 of the upper part 3 or of the lower segment 3.1.2 of the cylindrical passage 3.1, it matches the height of the lower segment 10.2 of washer 10. Recesses 1.1 may of course be omitted when adjusting the height of the lower segment 10.2 of washer 10.

Screws 9 and washers 10 may of cause be replaced by any adequate device, for instance an integral piece such as a screw having an appropriately shaped head, or the attachment could also be accomplished by other means than by screwing into movement 1, for instance with a bayonet fitting or even by gluing, welding, etc.

It is sketched in FIGS. 4a to 4d that the inner wall of the bell-shaped upper part 3 also has an annular groove 3.4 able to accept an elastic element 12, 13, 14 sitting on the periphery of movement 1, in order to position the bell-shaped upper part 3 on movement 1. The elastic element may consist of an open annular spring 12, as shown more particularly in perspective in FIG. 4d. This annular spring 12 may sit in an annular groove 1.2 on the outside of movement 1, see FIG. 4a, and snap into the annular groove 3.4 of upper part 3 after positioning the upper part 3 on movement 1. This can be seen more particularly in FIG. 4c. The opposite constellation, that is, a positioning of the annular spring on the case's upper part 3 and engagement of the spring into a groove 1.2 of the movement is one of possible variants, of course, as sketched in FIG. 4b. The elastic element may also be made as a gasket 13, see FIG. 5c, sitting in an annular groove 1.2 on the periphery of movement 1, as shown in FIG. 5a. Instead of positioning the elastic element without pressure, as in the cases described so far, it may be attached under pressure by compressing it between movement 1 and upper part 3 as shown in FIG. 5b. Another possible embodiment for positioning the upper part 3 on movement 1 is an elastic element in the shape of an elastic button 14, according to FIGS. 6a to 6c. In this case several elastic buttons 14 are situated preferably at the periphery of movement 1, and may then with or without additional pressure snap into groove 3.4 of the case's upper part 3, according to FIG. 6a and FIG. 6b, respectively.

It is the result of these measures that upper part 3 is mobile when attached to the movement 1, in a plane parallel to movement 1, while it is virtually stuck in a direction normal thereto. In view of this horizontal mobility of the upper part, the requirements as to the tolerances in centering of the bell-shaped segment of upper part 3 and the ring-shaped segment of the lower part 4, 5 can be lowered, since this will be compensated by the mobility of these two parts during assembly. At the same time, the requirements as to the tolerances of the diameters of these two parts may be raised. On the one hand, this leads to an obvious simplification of manufacture of these parts and of assembly of the case. On the other hand, the screening action is improved, since in this way upper and lower part have a better mutual fit, reducing the annular gap between these parts and with it the interfering magnetic field within the case.

Another advantage is due to the fact that the top surface 10.4 of washers 10 secures a spacing between a dial 6 that is fastened above the bell-shaped upper part 3, and the top surface of said bell-shaped part 3, this spacing being of the order of magnitude of a few hundredths of a millimeter. This is achieved by making the height of the upper segment 10.1 of the washers 10 somewhat larger than the height of the upper segment 3.1.1 of the cylindrical passage 3.1, such that the top surface 10.4 of washers 10 projects beyond the top surface of the bell-shaped upper part 3. Since upper part 3 as a rule is attached to movement 1 with at least three screws 9 and associated washers 10, their surfaces form a support surface for dial 6 that is exactly parallel to the plane of movement 1. Any contact between dial 6 and upper part 3 will thus be avoided. Moreover, anchoring pipes 11 can be mounted so as to envelop the display arbors and other display trains of movement 1 penetrating the bell-shaped upper part 3. In this case the surface of the end of the anchoring pipe that is turned toward dial 6 is attached slightly below the plane constituted by the top surfaces 10.4 of washers 10, by a few hundredths of a millimeter. This end of the anchoring pipes 11 thus secures support for the dial 6 that is fastened above the bell-shaped upper part 3, and its spacing from the top surface of the bell-shaped upper part 3. A deformation of dial 6 that might for instance happen when removing a hand, possibly requiring pressure of a tool to be applied to dial 6, is thus ruled out, since the bottom side of the dial is immediately supported by anchoring pipe 11 after a few hundredths of a millimeter of elastic yield. In FIG. 3, two such anchoring pipes 11a, 11b for the main display and a secondary display are indicated. These pipes may for instance each sit on a corresponding bridge of the movement.

The bell-shaped upper part 3 also has small through holes 3.3a, 3.3b admitting the feet of dial 6 by means of which dial 6 is fastened to movement 1, as also indicated in FIG. 3. As mentioned, a conventional dial made of a suitable alloy may be selected owing to the separation between dial 6 and the case's upper part, as well as to the support areas on the washers 10 and on anchoring pipes 11. Thus, the difficulties associated with the use of soft iron for the dial that were mentioned at the outset are removed.

The protecting case is assembled around movement 1 in known manner, except for the positioning of upper part 3. First the upper part 3 of the case is attached with screws 9 and washers 10 or equivalent means to movement 1. Then dial 6 can be fastened to movement 1. Then the annular middle part 4 is fastened to movement 1 prior to introducing the winding stem and other parts inserted from the side. Here the upper part 3 finds its position with the aid of the elastic elements 12, 13, 14, and it may furthermore be moved in a horizontal direction by the play of a few tenths of a millimeter so as to cling in the best possible way to the middle part 4. Despite the fixed arrangement of the screws 9, the upper part 3 is able to move in a direction parallel to movement 1 while the middle part 4 is attached to movement 1, so that it will snap into the middle part 4 and compensate tolerances that may be present, yet without touching dial 6. Then the entire assembly is slipped into case 2 of the time piece, with crystal 8 topping it, finally the bottom 5 of the screening case and the spring 15 are attached and the timepiece closed off with the bottom of case 2 of the timepiece.

The screening case according to the invention functions according to the principle that it consists of two or three parts mounted onto the movement, and able to move relative to each other while the dial functionally and structurally is separate from the parts of the screening case. This yields the advantages mentioned above, with respect to manufacture, manipulation, and protective effect of the inner case acting as an antimagnetic screen.

A protecting case according to the invention may be applied more particularly in timepieces that by themselves contain sources of magnetic fields, such as a magnetic clutch between a rotating outer ring and an inner bezel 7 coupled magnetically with this ring and often found in world timepieces, diving watches, and the like. The movement is effectively screened by such a device against a relatively strong magnetic field acting from outside the movement onto the case of the timepiece.

1. Case for a screening of magnetic fields, comprising at least two parts, a lower part (4, 5) and a bell-shaped upper part (3), adapted to envelop a movement (1) of a timepiece, characterized in that the bell-shaped upper part (3) is attached in such a way that it may move within a plane parallel to the movement (1) while it is essentially immobile in a direction normal to this plane.

2. Case according to claim 1, characterized in that the mobility of the attachment of the bell-shaped upper part (3) in the plane parallel to the movement is accomplished with screws (9) and washers (10).

3. Case according to claim 2, characterized in that each washer (10) in its longitudinal direction has two segments (10.1, 10.2) differing in their diameters, the bottom side (10.3) of the upper, larger segment (10.1) of washer (10) being adapted to hold the bell-shaped upper part (3) against the movement (1).

4. Case according to claim 2, characterized in that the upper surface (10.4) of washers (10) provides that dial (6) that is mounted above the bell-shaped upper part (3) will be in a spaced-apart position from the surface of the bell-shaped upper part (3).

5. Case according to claim 4, characterized in that around the display arbors of the movement (1) that penetrate the bell-shaped upper part (3), anchoring pipes (11) are mounted, their upper surface turned toward the dial (6) being slightly below the upper surfaces (10.4) of the washers (10) so that support of the dial (6) that is attached above the bell-shaped upper part (3), and its spaced-apart position from the surface of the upper bell-shaped part (3) are secured.

6. Case according to claim 3, characterized in that the bell-shaped upper part (3) has cylindrical passages (3.1) for the screws (9) and washers (10), each of said passages (3.1) including two segments (3.1.1, 3.1.2) differing in their diameters and slightly larger in their dimensions than the corresponding segment (10.1, 10.2) of the washer (10) to be positioned in them.

7. Case according to claim 3, characterized in that opposite to the cylindrical passages (3.1) of the bell-shaped upper part (3), movement (1) has recesses (1.1) with diameters slightly larger than the diameter of the lower segment (10.2) of washer (10), and with a height that, taken together with the thickness of the lower segment (3.1.2) of the cylindrical passage (3.1), matches the height of the lower segment (10.2) of washer (10).

8. Case according to claim 1, characterized in that the inner wall of the bell-shaped upper part (3) has an annular groove (3.4) into which an elastic element (12, 13, 14) sitting on the outer wall of movement (1) may engage so as to position the bell-shaped upper part (3) on movement (1).

9. Case according to claim 8, characterized in that the elastic element is formed as an open annular spring (12) sitting in an annular groove (1.2) on the outside of movement (1).

10. Case according to claim 9, characterized in that the elastic element is formed as a gasket (13) sitting in an annular groove (1.2) on the outside of movement (1).

11. Case according to claim 10, characterized in that the elastic element is formed as an elastic button (14).

12. Case according to claim 1, characterized in that the bell-shaped upper part (3) has through holes (3.3) admitting feet of a dial (6) serving to fasten the dial (6) to the movement (1).

13. Case according to claim 1, characterized in that the lower part consists of two separate parts, a bottom (5) and an annular middle part (4), that can be joined together.

14. Case according to claim 1, characterized in that the lower part (4, 5) and the bell-shaped upper part (3) consist of magnetically nonconductive material.

15. Case according to claim 14, characterized in that the lower part (4, 5) and the bell-shaped upper part (3) consist of soft iron.

16. Timepiece, and more particularly wristwatch, characterized in that it comprises a case according to claim 1.

17. Case according to claim 4, characterized in that the bell-shaped upper part (3) has cylindrical passages (3.1) for the screws (9) and washers (10), each of said passages (3.1) including two segments (3.1.1, 3.1.2) differing in their diameters and slightly larger in their dimensions than the corresponding segment (10.1, 10.2) of the washer (10) to be positioned in them.

18. Case according to claim 5, characterized in that the bell-shaped upper part (3) has cylindrical passages (3.1) for the screws (9) and washers (10), each of said passages (3.1) including two segments (3.1.1, 3.1.2) differing in their diameters and slightly larger in their dimensions than the corresponding segment (10.1, 10.2) of the washer (10) to be positioned in them.

19. Case according to claim 3, characterized in that the upper surface (10.4) of washers (10) provides that dial (6) that is mounted above the bell-shaped upper part (3) will be in a spaced-apart position from the surface of the bell-shaped upper part (3).

20. Case according to claim 4, characterized in that opposite to the cylindrical passages (3.1) of the bell-shaped upper part (3), movement (1) has recesses (1.1) with diameters slightly larger than the diameter of the lower segment (10.2) of washer (10), and with a height that, taken together with the thickness of the lower segment (3.1.2) of the cylindrical passage (3.1), matches the height of the lower segment (10.2) of washer (10).
